(19) United States
(12) Patent Application Publication
(10) Pub. No.: US 2007/0205279 A1
(43) Pub. Date: Sep. 6, 2007

(54) Integrated explosives detector and transit fare collection system and method

(75) Inventor: Kurt Bistany, Methuen, MA (US)

Correspondence Address: CASELLA & HESPOS, 274 MADISON AVENUE, NEW YORK, NY, 10016, US

(73) Assignee: GE Security, Inc., Bradenton, FL (US)

(21) Appl. No.: 11/516,248

(22) Filed: Sep. 6, 2006

Related U.S. Application Data
(60) Provisional application No. 60/779,061, filed on Mar. 3, 2006.

(51) Int. Cl. G07B 15/02; G06K 5/00

(52) U.S. Cl. 235/384; 235/382

(57) ABSTRACT

An integrated fare collection and security system is provided. The system include an apparatus for detecting trace amounts of explosives or other substances of interest as part of a ticket purchasing transaction. Signals then are generated to prevent suspects form entering the transit system.

This application claims priority on U.S. Provisional Patent Appl. No. 60/779,061, filed Mar. 3, 2006.

### BACKGROUND OF THE INVENTION

1. Field of the Invention

The invention relates to a system and method for detecting explosives as part of the fare collection for a transit system.

2. Description of the Related Art

Terrorism risks continue to increase at transportation facilities and other locations where there is a significant flow of pedestrian or vehicular traffic. As a result, virtually all airports and many other buildings now include apparatus for detecting trace amounts of explosives.

Narcotics are illegal and insidious. Furthermore, it is known that many terrorists organizations fund their terrorism through the lucrative sale of narcotics. Accordingly, many airports and other public buildings recognize the need to check for narcotics.

U.S. Pat. No. 5,200,614 discloses a device that employs an ion trap mobility spectrometer that can be operated in a negative ion mode to test for trace amounts of explosives. U.S. Pat. No. 5,491,337 shows an improved ion trap mobility spectrometer with an enhanced ability to operate in a positive ion mode for identifying trace amounts of narcotics. U.S. Pat. No. 6,765,198 discloses an ion trap mobility spectrometer that can be switched quickly from the positive mode to the negative mode so that a single sample can be tested for the presence of trace amounts of either explosives or narcotics. Detectors that incorporate the technology disclosed in U.S. Pat. No. 5,200,614, U.S. Pat. No. 5,491,337 and U.S. Pat. No. 6,765,198 are marketed by GE Security, Inc. and perform very well. The disclosures of U.S. Pat. No. 5,200,614, U.S. Pat. No. 5,491,337 and U.S. Pat. No. 6,765,198 are incorporated herein by reference.

Prior art detectors have used many techniques for delivering a sample into the detector to test the sample for substances of interest. For example, some detectors employ small flexible fabric-like traps that can be wiped across a package or piece of luggage. The trap removes residue from the surface of the package or luggage. The trap then is placed in an apparatus, such as an ion trap mobility spectrometer, that tests the residue on the trap for trace amounts of explosive materials or narcotics.

Detectors that rely upon wiping a flexible fabric trap across a piece of luggage impede the flow of pedestrians through a check point, and hence typically are used only for spot checks at airports or government buildings where pedestrian traffic is relatively low and where delays can be tolerated. Additionally, an explosive or narcotic detector of this type would not identify contraband worn by a passenger or other pedestrian who was not carrying luggage.

U.S. Pat. No. 6,073,499 discloses a walk-through detector. The detector shown in U.S. Pat. No. 6,073,499 operates under the principle that a boundary layer of air adjacent to a person is heated by the person. This heated air adjacent a person is less dense than air further from the person. Less dense air rises. Accordingly, a thermal plume of air flows up adjacent to a person. Minute particles, including particles of explosives or narcotics, will be entrained in this thermal plume of air and will flow upwardly from a person. The walk-through detector disclosed in U.S. Pat. No. 6,073,499 employs an ion mobility spectrometer or ion trap mobility spectrometer to detect microscopic particles of interest that are likely to be entrained in the thermal plume of air flowing upwardly adjacent to a person who walks through and pauses briefly in the detector. The walk-through detector disclosed in U.S. Pat. No. 6,073,499 is very effective for detecting whether a person is carrying explosives or narcotics and whether the person has recently handled explosives or narcotics. However, the walk through detector of U.S. Pat. No. 6,073,499 is large and is not suitable for access points the experience high peak flows of pedestrian traffic.

The effectiveness of the above-described explosive detectors have caused terrorists to shift the focus of their activities from the increasingly secure airports to the highly accessible and less secure public transit systems. Many public transit systems accommodate passenger volumes that are significantly higher than the passenger volumes at the busiest airports. Passenger volumes at public transit hubs tend to have very well pronounced peaks near 8:00 or 9:00 am and again near 5:00 or 6:00 pm. These high peaks would complicate efforts to operate public transit security checkpoints comparable to the security checkpoints that exist at airports. Furthermore, airline travelers generally can arrange their travel schedule to arrive at the airport two hours early to ensure sufficient time for security clearance. On the other hand, commuters would almost certainly abandon public transit if they were required to arrive at the train or subway two hours before their expected departure.

Most public transit systems currently dispense tickets and/or fare cards from vending machines. The typical vending machine includes a series of audible and/or visual prompts to guide the transit passenger through several steps required for purchasing a ticket or fare card or for reloading fares onto an existing fare card. The vending machine requires the passenger to clarify whether the transaction is for the purpose of receiving a new ticket or fare card or for reloading fares onto an existing card. The passenger then may be given the opportunity to select payment by cash, debit card or credit card. A cash transaction requires the passenger to feed bills sequentially into a bill processor of the vending machine. A credit card or debit card transaction requires the passenger to insert the credit or debit card into a slot of the vending machine and then to choose an appropriate monetary amount that is to be charged or debited. The vending machine then either prints a ticket or encodes a magnetic strip on the fare card with a monetary amount corresponding to the amount of the transaction chosen by the passenger. The process of buying or loading a fare card typically takes at least 20-30 seconds.

Many transit stations are situated near parking garages. Some parking garages require parkers to prepay for use of the facility. For example, a parker may use cash or a credit card to purchase a parking receipt. The parker then returns to the car and places the prepaid receipt at a specified location on the dash board. Parking attendants or local parking police will periodically inspect cars to ensure that the prepaid parking receipt is displayed in an appropriate manner. A parking violation notice or summons may be placed on a car that has not paid the required fee.

The subject invention was made in view of the state-of-the-art described above. Accordingly, it is an object of the invention to provide security at and near public transit facilities.

Another object of the invention is to permit explosive detection at public transit facility.

A further object of the invention is to permit explosive detection at public transit facilities without significantly impeding the flow of passengers through the public transit facilities.

### SUMMARY OF THE INVENTION

The invention relates to an integrated system for substantially simultaneously receiving a fare for using part of a transportation system and for determining if the passenger has used explosives or narcotics. In a preferred embodiment, an apparatus for detecting trace amounts of explosive materials is structurally and/or functionally associated with an apparatus for receiving or processing transit fares. The apparatus for detecting trace amounts of explosive materials preferably comprises a detector and a device for collecting samples and transferring samples to the detector for analysis. The detector preferably is an ion trap mobility spectrometer, such as the types disclosed in U.S. Pat. No. 5,200,614 or U.S. Pat. No. 5,491,337. The apparatus for collecting and transferring a sample may be the apparatus disclosed in published U.S. Patent Publication No. 2005/0019220, which relates to collecting substances of interest from a card that is swiped through a card reading slot. The device for collecting and transferring a sample also may be the device disclosed in pending U.S. Pat. No. 7,047,829 which functions by removing residue from the fingers of a person being screened. The disclosures of published U.S. Patent Publication No. 2005/0019220 and U.S. Pat. No. 7,047,829 are incorporated herein by reference.

The apparatus for collecting or processing the transit fare may be a vending machine for issuing a ticket or fare card or for reloading a transit fare card. In this embodiment, the vending machine may require the passenger to press his or her finger(s) on sample collecting surface to initiate operation of the vending machine. The sample collecting surface then may be rotated or translated into a portion of the apparatus that heats the surface sufficiently to vaporize any residue transferred from the finger(s) of the passenger. The vaporized residue then may be transported on a stream of air into the detector, such as the above-described ion trap mobility spectrometer. The detector tests the sample for the presence of substances of interest, such as TNT, RDX or other explosives. The detecting process is carried out while the passenger is performing the sequence of steps that is required to obtain a new ticket or fare card or to reload an existing fare card. The fare card processing typically takes at least 20-30 seconds. The detector, on the other hand, can analyze a sample in about 7-8 seconds. As a result, the presence of a substance of interest can be identified well prior to the receipt of the ticket fare card for use.

In some embodiments, the transit fare processing apparatus can include an access control system, such as a turnstile, gate or the like that requires a passenger to swipe a card or ticket through a slot or to insert the card or ticket into a slot. The turnstile, gate or the like can be connected operatively to the fare card vending machine or to a controller so that a passenger is denied access to internal portions of the transit system if the substance of interest has been detected as part of the transaction to purchase the ticket or fare card or reload the fare card.

The apparatus may further include a central controller connected electronically with the detector and the fare processing apparatus. The controller may be connected to a plurality of detectors and will receive a signal if any of the detectors senses the presence of a substance of interest. The controller may then generate a signal to prevent access to the passenger who is carrying the ticket or fare card that was purchased or reloaded when the substance of interest was detected by the vending machine. Additionally, the control unit will send signals to security personnel who will be alerted to the existence of a significant security risk. The signals directed to the security personnel can include video signal with images of the suspect. These video signals can be directed to hand-held PDAs carried by the security personnel.

### BRIEF DESCRIPTION OF THE DRAWINGS

FIG. 1 is a schematic representation of an entrance area of a public transit station.

FIG. 2 is a flow diagram showing the interrelationship between the various integrated components of the system of the subject invention.

FIG. 3 is a schematic front elevational view of a vending machine for purchasing or recharging a ticket.

FIG. 4 is a schematic perspective view, partly in section, of the sample collection portion of the detector apparatus.

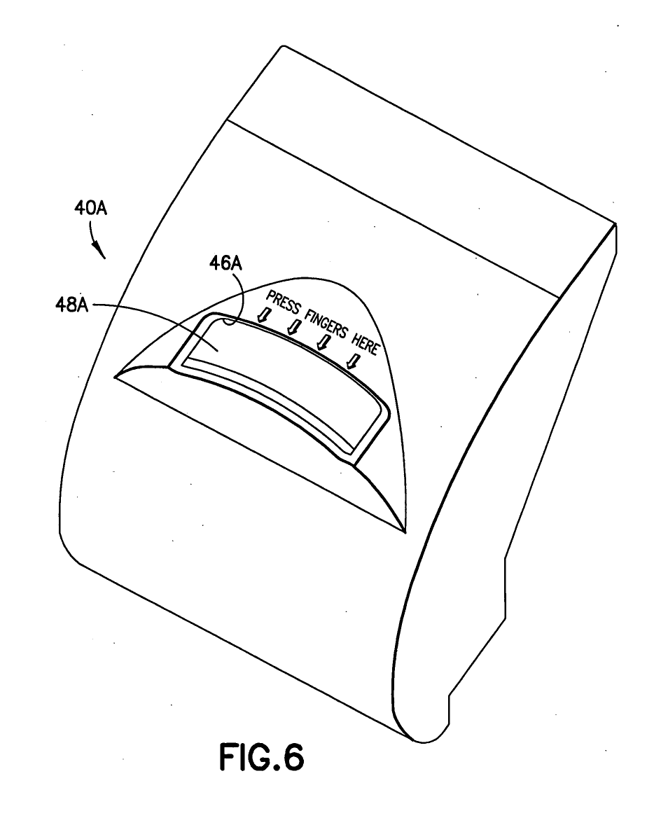

FIG. 5 is a schematic cross-sectional view of the ion trap mobility spectrometer of the detector apparatus.

FIG. 6 is a schematic view of an alternate sample collection apparatus.

FIG. 7 is a schematic view a further embodiment for collecting a sample from the card inserted into the vending machine for purchasing a transit ticket or fare card.

FIGS. 8A, 8B and 8C are flow diagrams of the subject system.

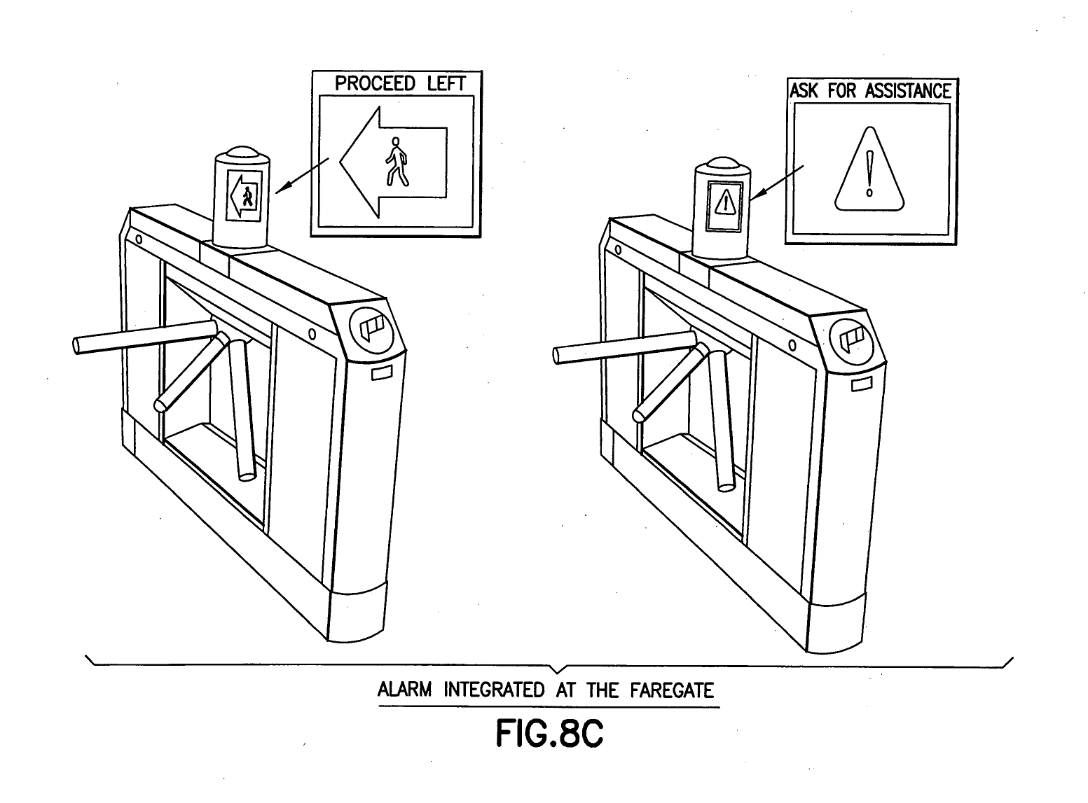

### DETAILED DESCRIPTION OF THE PREFERRED EMBODIMENTS

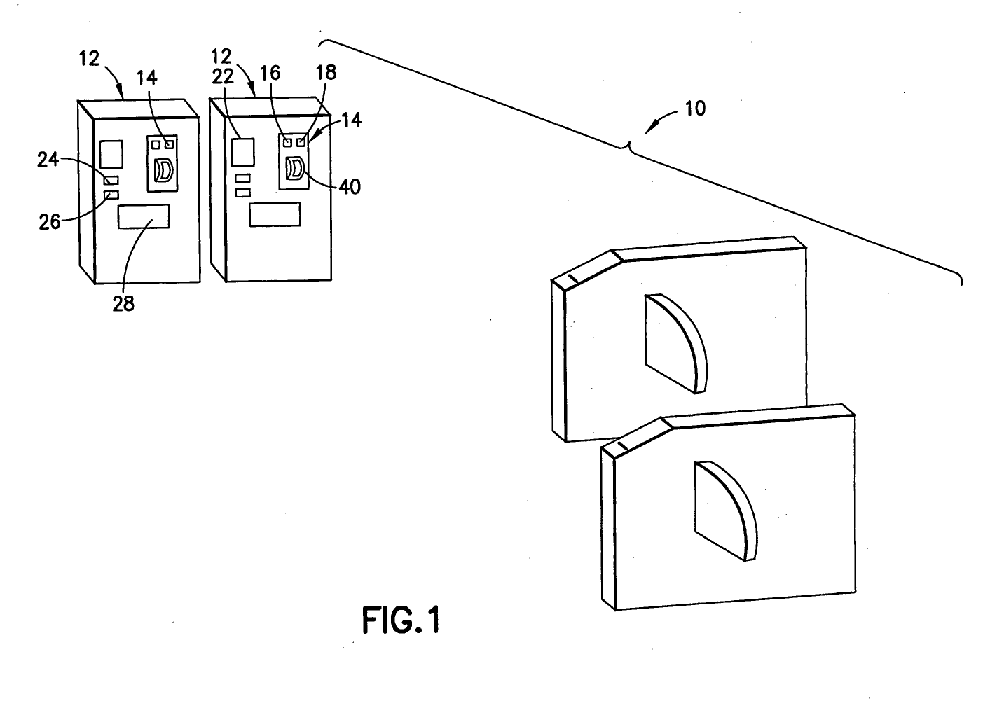

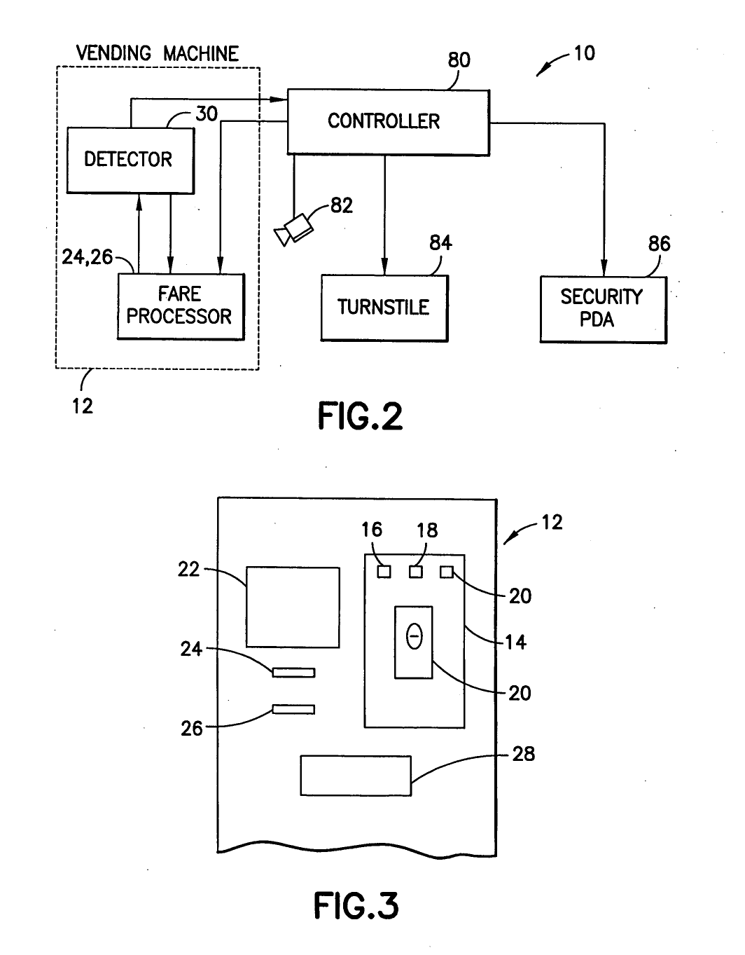

A secure mass transit access system in accordance with the invention is identified generally by the numeral 10 in FIGS. 1 and 2. The system 10 includes at least one transit fare vending machine 12 that may include components currently used on ticket or fare card vending machines. In this regard, the vending machine 12 includes a user input region 14 with switches 16 and 18 that enable a passenger to issue appropriate instructions for buying a ticket, buying a fare card or reloading a fare card. The vending machine further include a monitor 22 for issuing step-by-step operating instructions for guiding the passenger through a ticket or fare card transaction. In some embodiments, the monitor 22 will be a touch screen monitor that permits the user to input ticket or fare card purchasing instructions to the vending machine 12.

The vending machine 12 further includes at least one currency slot 24 and/or a credit card slot 26. The currency slot 24 communicates with a known cash and/or coin feeding mechanism. The credit card slot 26 communicates with a known credit card reader. The vending machine 12 further includes an output window 28 for feeding a ticket or fare card to the passenger. The output window 28 may further include a change receptacle for returning change to the passenger.

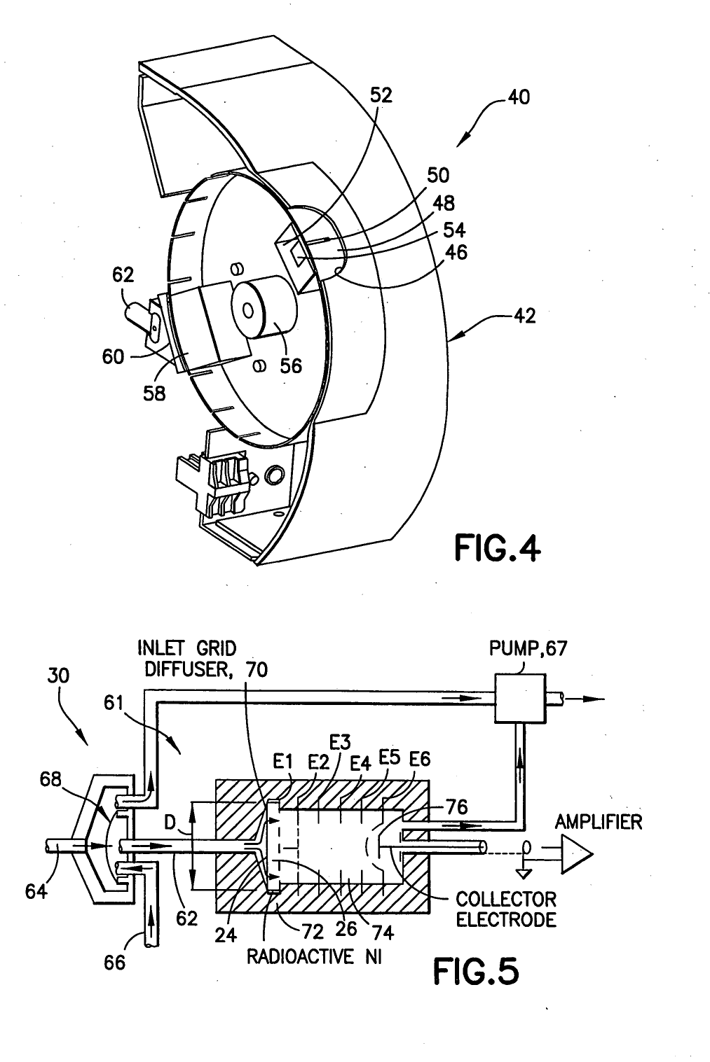

The vending machine 12 also includes a detector 30 with a sample collection apparatus 40 that is partly accessible to the passenger at the user input region 14 of the vending machine 12. The sample collection apparatus 40, as shown in greater detail in FIG. 3, includes a housing 42 with a window 46 at a position on the vending machine that will face the person purchasing a ticket or fare card or reloading a fare card. The window 46 is configured and dimensioned to receive substantially all of the gripping surface of the distal digit on a thumb or forefinger.

The sample collection apparatus 40 further includes a generally cylindrical drum 48 mounted in the housing 42 for rotation about an axis that is parallel to the front face of the vending machine 12. More particularly, the cylindrical drum 48 is disposed to be substantially internally tangent with portions of the housing 42 adjacent the window 46. Hence, a target area on the exterior of the drum 48 will be exposed at the window 46. The drum 48 is formed from a material that will retain residue from the hand of a person being screened. The material of the drum 48 also must be able to be heated quickly and repeatedly to sufficiently high temperatures for vaporizing residue received from the hand. Additionally, the material of the drum 48 should be capable of being cooled quickly to prevent discomfort when a finger is placed on the drum 48 and to maintain a desirably low cycle time for scanning. The material of the drum can be a non-metallic material or a thin metallic material, such as aluminum or stainless steel. Aluminum exhibits desirable heating and cooling characteristics and exhibits a long life. The thickness of the material of the drum 48 also is selected to facilitate rapid heating and cooling. A thickness in the range of 0.002-0.020 inch is preferred. The relatively thin material of the drum 48 also permits slight inward deflection of the drum 48 in response to digital pressure created by a thumb or forefinger placed on or wiped across the target area of the drum 48 exposed at the window 46. This deflection can trigger a pressure sensitive switch to activate a scanning cycle and to initiate a transit fare transaction by the vending machine 12.

The drum 48 further includes a plurality of slots 50 that extend entirely through the material of the drum 48. The slots 50 perform several functions. The slots 50 remove mass from the drum 48 and break the conductive heat transfer path to facilitate rapid heating and cooling of the drum 48. The slots 50 also accommodate air flow to facilitate cooling. Additionally, the slots 50 facilitate deflection of the drum 48 that may trigger the pressure sensitive switch.

The sample collection apparatus 40 further includes a pressure sensitive switch 52 fixedly mounted to the housing 42 at a location radially aligned with the window 46 and inwardly from the drum 48. The switch 52 senses small deflections of the drum 48 as the thumb or forefinger is pressed on or wiped across portions of the drum 48 in the window 46. Thus, the switch 52 can generate a signal to activate a transit fare transaction and a scanning cycle that tests for the presence of at least one substance of interest.

The sample collection apparatus 40 further includes a motor 56 mounted in the housing 42 and operative to rotate the drum 48. The motor 56 is connected to the switch 52 and functions to rotate the drum 48 a selected amount in response to the sensed pressure of a thumb or forefinger on portions of the drum 48 disposed in the window 46.

The sample collection apparatus 40 further includes a desorber 58 mounted to the housing and disposed interiorly of and adjacent to the drum 48. The desorber 58 functions to rapidly heat portions of the drum 48 aligned with the desorber 58 for vaporizing trace amounts of material transferred from the thumb or forefinger to the target area of the drum 48 that was exposed at the window 46. The desorber 58 preferably is always on when the detector 10 is on to avoid a need for preheating during each scanning cycle. A sample transfer box 60 is mounted to the housing 42 at a location radially aligned with the desorber 58, but disposed exteriorly of and substantially adjacent the drum 48. The desorber 58, and the sample transfer box 60 have opposed facing surfaces that are curved with radii of curvature substantially corresponding to the inner and outer circumferential shapes of the drum 48. A sample tube 62 extends from the sample transfer box 60.

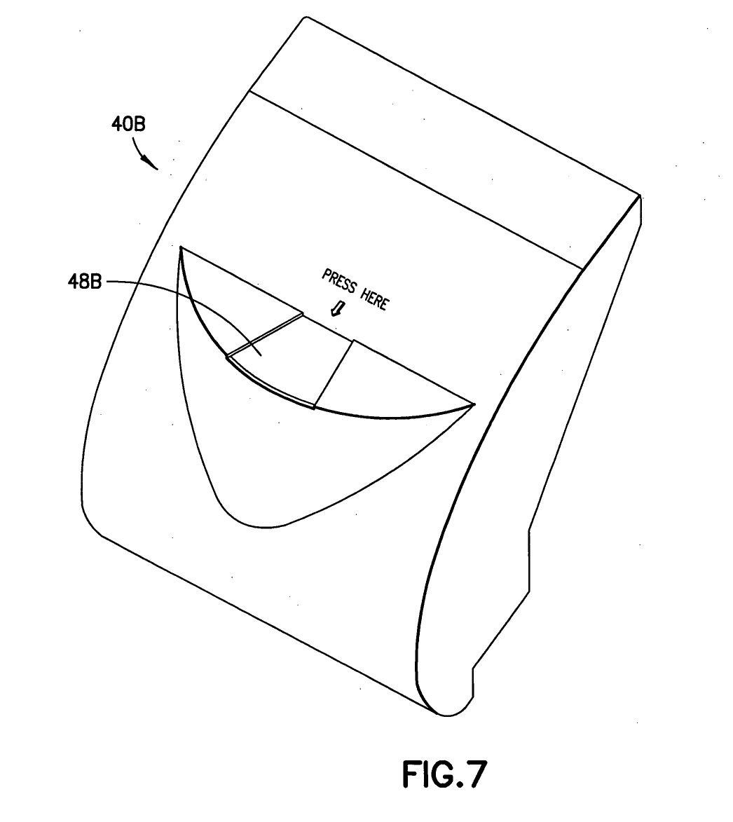

The detector 30 further includes an ion trap mobility spectrometer, which is shown schematically in FIG. 5. The ion trap mobility spectrometer comprises a cylindrical detector 61 having an inlet 62 at one end for receiving sample air of interest borne by a carrier gas which that has been doped with a low concentration vapor (typically a few parts per million) employed as a charge transfer mediator. More particularly, the inlet 62 communicates with a source of sample air of interest 64 and a supply of carrier gas and dopant 66 with flows of gases to the inlet 62 being enabled by a flow generator such as a pump illustrated schematically and identified by the numeral 67 in FIG. 5. A heated membrane 68 formed from a microporeous refractory material or from dimethyl silicone is disposed near the inlet 62 and in communication with the source of the sample of air 64 for blocking passage of at least selected constituents of the air and for enabling passage of other constituents of the air, including the constituents of interest. The sample air, carrier gas, and dopant molecules pass through the inlet 62 and are spread by a diffuser 70 into an ionization chamber 72. The ionization chamber 72 is in the form of a shallow cylinder with a radioactive material, e.g., nickel⁶³ or tritium that emits beta particles. The inlet 62 communicates with one end of the ionization chamber 72. A grid electrode E₁ is provided at the end opposite the inlet 62, and is normally maintained at the same potential as the inlet end and the walls of the ionization chamber 72. Thus a largely field-free space is provided in which electrons and ion charges build up and interact with the sample molecules under bombardment by the beta-particles from the radioactive walls. The ionized sample gases pass through the open electrode E₁ and into an ion drift region 74 having several field-defining electrodes E₂-Eₙ. A collector electrode or plate 76 is disposed at the end of the drift region 74 for receiving the ion samples reaching that end.

Periodically a field is established across the ionization region 72, by creating a potential difference between the grid electrode E₁ and the wall of the ionization region 72 for about 0.1-0.2 mS, to sweep the ions through the open grid E₁ into the drift region 74 with the assistance of the switching of the field between electrodes E₁ and E₂. The ions in the drift region 74 experience a constant electric field, maintained by the annular electrodes E₂-Eₙ, impelling them along the region and down toward the collector electrode 76. The collector electrode 76 detects the arriving charge, and produces signals that are amplified and analyzed in the spectrometer on the basis of their spectra. The gases exit through an outlet in the wall next to the collector electrode 76. After about 0.2 mS, the field across the ionization region 72 is reduced again to zero and the ion population is allowed to build up in the ionization chamber 72 preparatory to the imposition of the next field. The polarity of the fields is chosen on the basis of whether the ion trap mobility spectrometer is operated in a negative or positive ion mode. When detecting explosives, a negative ion mode is usually appropriate, but when detecting narcotic samples positive ion mode is preferred. Explosives create a much higher risk at mass transit stations, and hence a negative mode is the preferred operation.

The system of FIGS. 1 and 2 further includes a controller 80 that communicates with each of the vending machines 12. Accordingly, the detector 30 incorporated into the vending machine 12 generates a signal to the controller 80 in response to a sensed substance of interest. The controller 80 further communicates with video camera 82 in proximity to the vending machine 12, turnstiles 84 and PDA's 86 of security personnel. Thus, in response to a sensed substance of interest, the controller 80 will generate a signal for taking a picture or video stream of the passenger associated with the sensed presence of a substance of interest. The controller 80 then encodes the ticket or fare card of the suspected passenger. The passenger normally will proceed from the vending machine 12 to the turnstile 84 for entry into the transit system. The turnstile 84 includes a ticket or fare card slot 86 for receiving a ticket or fare card of the passenger. Normally, the turnstile 84 will operate to permit the passenger to pass through the turnstile 84 and into the transit system. However, the turnstile 84 communicates with the controller 80 and denies entry to an individual with a ticket or fare card that has been identified as being associated with a substance of interest or a ticket that has been encoded appropriately by the controller 80 to identify a suspected passenger. As a result, the passenger suspected of having a substance of interest is denied entry into the interior of the transit system.

The controller 80 also generates a signal to the PDA's 86 of security personnel who will move into position for apprehending or questioning the passenger/suspect. The signal sent to the PDA's 86 of security personnel can be an audible signal and/or a video signal to provide visual image of the suspect. Hence, security personnel can act appropriately to prevent entry of the suspect into the transit system.

In an alternative embodiment, when the detector 30 generates a signal to the controller 80 in response to a sensed substance of interest, the controller 80 can communicate with a central monitoring station (not shown) to alert security personnel of the detection of a substance of interest. The controller 80 can issue a signal preventing the vending machine 12 from issuing a ticket or fare card to the passenger and instruct the passenger to remain at the vending machine 12 or, in the alternative, to go a defined location. A picture of the individual is taken, stored, and possible transmitted to a PDA carried by a security personnel.

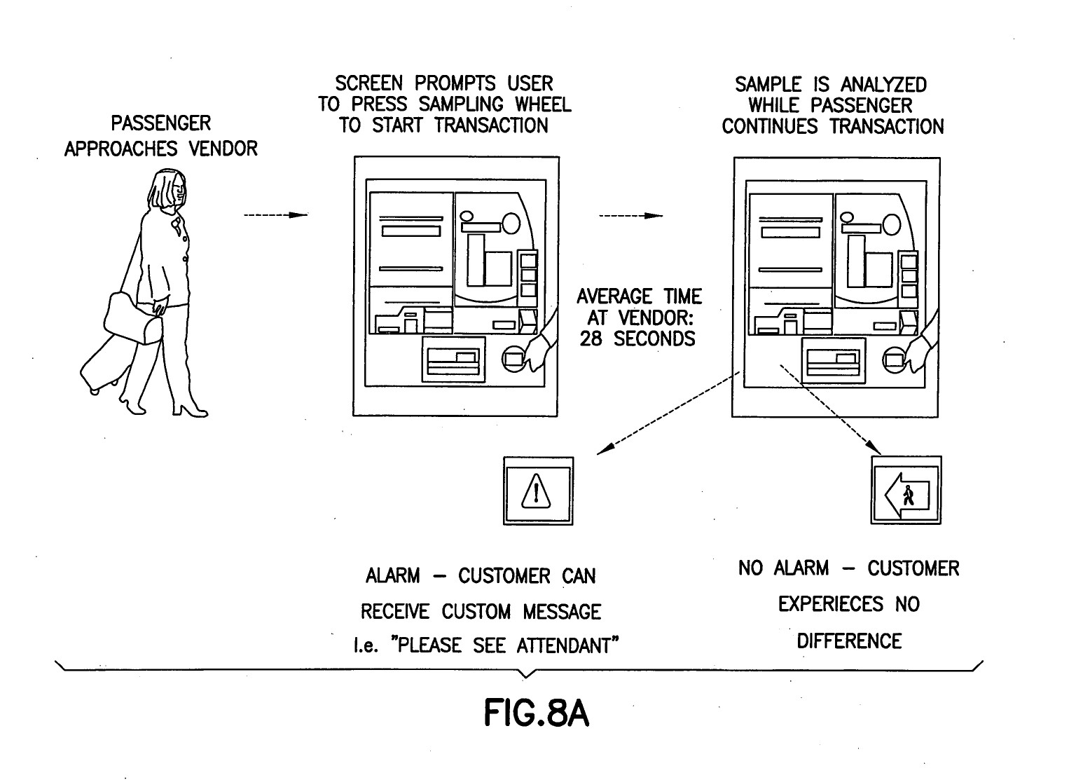

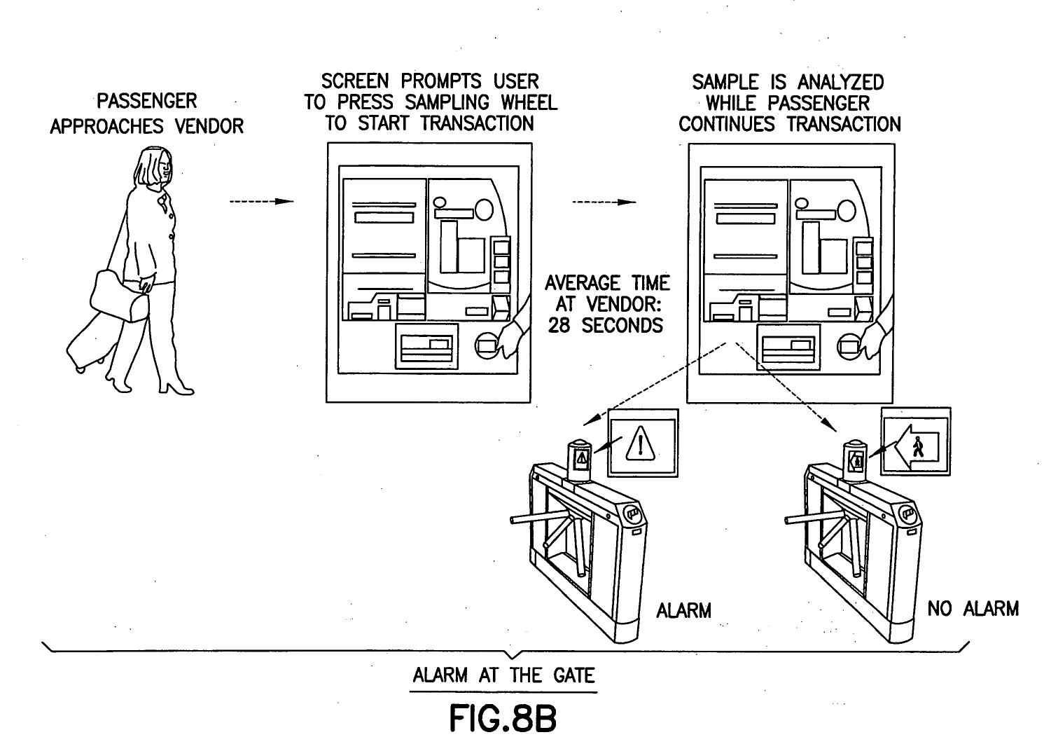

The sample collection apparatus can take other configurations. For example, FIG. 6 shows a sample collection apparatus 40A with a drum 48A mounted for rotation about an axis aligned at an angle, and preferably a right angle, to the front face of the vending machine 12. The window 46A is sufficiently wide to place all forefingers of one hand on a portion of the drum 48A exposed at the window. FIG. 7 shows a detector 40B with an aluminum disc 48B in place of the drum. The disc 48B rotates about a substantially vertical axis. Other options can include a thin plate that translates without rotation or a flexible belt that is driven about rollers.

While the invention has been described with respect to a preferred embodiment, it is apparent that various changes can be made without departing from the scope of the invention as defined by the appended claims.

1. An integrated fare processor and security apparatus for a transportation system, said apparatus comprising:
a ticket selector with at least one finger-actuated control for selecting at least one ticket option;
a payment receiver for receiving payment from a passenger for the selected ticket option;
a ticket issuer for issuing a ticket or fare card in response to the payment by the passenger;
a sample collector communicating with the ticket selector or the payment receiver for collecting a sample to be analyzed for a substance of interest; and
a detector communicating with the sample collector for identifying trace amounts of at least one substance of interest collected by the sample collector.

2. The apparatus of claim 1, wherein the detector is an ion trap mobility spectrometer.

3. The apparatus of claim 1, wherein the finger-actuated control comprises a sample collection sheet movably mounted in the ticket selector and responsive to digital pressure exerted by the passenger for initiating a ticket purchase, the sample collector further comprising a motor for moving the sample collection sheet into a position for testing residue on the sample collection sheet for the presence of the at least one substance of interest.

4. The apparatus of claim 1, further comprising a controller communicating with the detector and operative to generate at least one signal in response to the sensed presence of the substance of interest.

5. The apparatus of claim 4, wherein the controller further communicates with the ticket issuer, the ticket issuer further comprising an encoder for applying a security code to the ticket in response to the sensed presence of the substance of interest.

6. The apparatus of claim 5, wherein the ticket selector, the payment receiver, the ticket issuer, the sample collector and the detector are at a first location, the apparatus further comprising at least one turnstile control at a second location spaced from the first location, the turnstile control being operative for receiving the ticket and selectively permitting the passenger to access the transit system, the turnstile control being operative for denying access to a passenger associated with a ticket that has the security code applied thereto.

7. The apparatus of claim 4, further comprising a camera communicating with the controller, the signal generated by the controller being operative to activate the camera for producing a visual image of the passenger associated with the sensed presence of the substance of interest.

8. The apparatus of claim 7, wherein the controller further is operative to transmit the visual image to at least one remote location accessible by security personnel.

9. The apparatus of claim 1, wherein the payment receiver includes a card reader for reading a credit card or debit card, the sample collector being associated with the card reader for removing a sample from a card inserted into the card reader.

10. A method for screening passengers of a public transit system to identify trace amounts of at least one substance of interest, said method comprising:
instructing a passenger to initiate a ticket purchase transaction by applying digital pressure to a sample collection surface;
issuing instructions to the passenger and receiving input from the passenger for completing the ticket purchase transaction;
testing a sample collected on the sample collection surface during the ticket purchase transaction; and
generating a signal if the substance of interest is identified in the collected sample.

11. The method of claim 10, wherein the step of generating the signal comprises signaling an encoder to encode the ticket with a code indicative of a security risk.

12. The method of claim 11, further comprising presenting the ticket at a turnstile for access to the transit system and denying access if the turnstile detects the code on the ticket indicative of a security risk.

13. The method of claim 10, wherein the step of generating a signal comprises actuating a camera to generate an image of the passenger associated with the substance of interest.

14. The method of claim 13, further comprising the step of transmitting the image of the passenger to security personnel.

15. The method of claim 10, further comprising sending the signal to security personnel.

16. An integrated fare processor and security apparatus for a transportation system, said apparatus comprising:
a ticket selector with at least one finger-actuated control for selecting at least one ticket option, the finger-actuated control comprising a sample collection sheet as a permanent part of the ticket selector and responsive to digital pressure exerted by the passenger for selecting the ticket option;
a sample collector with a motor for moving the sample collection sheet of the ticket selector into a position for testing residue on the sample collection sheet for the presence of at least one substance of interest;
a detector communicating with the sample collector to analyze the sample collected from the sample collection sheet for the presence of trace amounts of at least one substance of interest collected on the sample collection sheet;
a payment receiver for receiving payment from a passenger for the selected ticket option while the detector is analyzing the sample collected on the sample collection sheet;
a ticket issuer for issuing a ticket or fare card in response to the payment by the passenger; and
a controller communicating with the detector and operative to generate at least one signal in response to the sensed presence of the substance of interest.

17. The apparatus of claim 16, wherein the controller further communicates with the ticket issuer, the ticket issuer further comprising an encoder for applying a security code to the ticket in response to the sensed presence of the substance of interest.

18. The apparatus of claim 17, further comprising at least one turnstile control for receiving the ticket and selectively permitting the passenger to access the transit system, the turnstile control being operative for denying access to a passenger associated with a ticket that has the security code applied thereto.

19. The apparatus of claim 16, further comprising a camera communicating with the controller, the signal generated by the controller being operative to activate the camera for producing a visual image of the passenger associated with the sensed presence of the substance of interest.

20. The apparatus of claim 16, wherein the detector is an ion trap mobility spectrometer.
